(19) United States
(12) Patent Application Publication
(10) Pub. No.: US 2013/0343639 A1
(43) Pub. Date: Dec. 26, 2013

(54) AUTOMATICALLY MORPHING AND MODIFYING HANDWRITTEN TEXT

(71) Applicants: Hrvoje Benko, Seattle, WA (US); Benoit Barabe, Redmond, WA (US)

(72) Inventors: Hrvoje Benko, Seattle, WA (US); Benoit Barabe, Redmond, WA (US)

(73) Assignee: Microsoft Corporation, Redmond, WA (US)

(21) Appl. No.: 13/528,757

(22) Filed: Jun. 20, 2012

(51) Int. Cl. G06K 9/40; G06K 9/62

(52) U.S. Cl. 382/155; 382/254

(57) ABSTRACT

An automatic handwriting morphing and modification system and method for digitally altering the handwriting of a user while maintaining the overall appearance and style of the user's handwriting. Embodiments of the system and method do not substitute or replace characters or words but instead morph and modify the user's handwritten strokes to retain a visual correlation between the original user's handwriting and the morphed and modified version of the user's handwriting. Embodiments of the system and method input the user's handwriting and a set of morph rules that determine what the handwritten strokes of the user can look more like after processing. Morphs, which are a specific type or appearance of a handwritten stroke, are selected based on the target handwriting. The selected morphs are applied using geometric tuning, semantic tuning, or both. The result is a morphed and modified version of the user's handwriting.

### BACKGROUND

Recognizing handwritten text is an area of great interest in both research and industry. Currently, many commercial solutions exist that recognize handwritten text. These handwriting recognizers are primarily used to convert handwritten text into properly formatted text using standard computer fonts (such as Arial, Times, and so forth). Typically, a handwritten recognition system reads the input handwriting, makes its best guess as to the word the handwriting represents, and makes a complete substitution of the word in handwritten form to the word in the computer font. Thus, for everything that a user has written there is a fonted version.

One issue with existing handwriting recognition techniques is that the system is forced to make a decision and take a best guess at recognizing the word. The system then makes a substitution based on that best guess. If a handwritten word is misrecognized and an incorrect word is substituted, the meaning may be completely different from the original intended meaning. This means that it is desirable that it be fixed manually. Otherwise the value of the conversion is lost completely.

Another issue is that the act of substituting the original handwritten ink strokes into standard fonts removes any “personality” from the text and makes the text appear standardized and impersonal. In many situations this impersonalization of the text is undesirable, especially when the author intends the text to remain personal and remain handwritten.

There also is an ever-decreasing emphasis placed on penmanship skills in schools and more emphasis placed on digital text entered using keyboards. Thus, without the opportunity to practice penmanship skills on a regular basis, it is plausible to assume that a person's handwriting skills are deteriorating. It is also plausible to assume that there will be a market in the future for notes that appear handwritten and completely personal.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the automatic handwriting morphing and modification system and method digitally alter the handwritten strokes of a user's handwriting such that the overall appearance and style of the user's handwriting is retained. Instead of complete substitution or replacement of characters in the user's handwriting, embodiments of the system and method instead morph and modify the user's handwritten strokes to maintain a visual correlation between the original user's handwriting and the morphed and modified version of the user's handwriting.

Embodiments of the handwriting enhancement and correction system and method generally morph digital ink strokes at the handwritten stroke level rather than replacing strokes with pre-designed font characters. This approach preserves at least some individual characteristics of a user's handwriting to make it appear as if the morphed and modified handwriting is actually the user's handwriting. Moreover, this approach is capable of providing assistance in making a user's handwriting more uniform, aligned, or consistent.

One difference from substitution approaches is that embodiments of the system and method do not have to be absolutely correct in order to morph and modify a handwritten stroke. The substitution approaches convert handwriting to text and are forced to make a decision as to what word the handwriting represents. The handwritten word then is replaced with text based on the recognized word. However, if a mistake is made in recognizing the word so that the wrong word is substituted, then the meaning of what the user has written may be completely different. Embodiments of the system and method are not forced to make a substitution or decision. A character or word can be morphed and modified without changing its meaning. Moreover, where semantic information is used, embodiments of the system and method can make a change on a portion of the user's handwriting in which there is a high confidence while leaving the other characters and words alone. This leaves us with an intermediate result, which is still an improvement over the initial handwritten input.

Embodiments of the system and method can enhance the user's handwriting that is in a printed style where individual characters of a word are not connected to each other. The user's handwriting can be enhanced by morphing and modifying the user's handwriting to connect the letters of the words and give the appearance of a more cursive style of handwriting. Moreover, embodiments of the system and method can reduce the user's handwriting that is in a cursive style where individual characters of a word are connected. The user's handwriting can be reduced by morphing and modifying the user's handwriting to separate the letters of the word and make the user's handwriting look more like a printed style of handwriting.

Embodiments of the system and method input the user's handwriting that contains handwritten strokes. The user's handwriting is morphed and modified based on a set of morph rules. The set of morph rules can be some predefined set of morph rules or a user can define these rules through a user interface that allows the user to tune the desired level of morphing. The morphing and modification is achieved while still retaining the overall style and appearance of the user's handwriting. Moreover, the amount of morphing and modifying can be adjusted on a continuum scale, such that the user's handwriting can be morphed and modified so that it has a small or large amount of the desired target handwriting characteristics and any amount in between. Moreover, desired target handwriting can be generated by adjusting attributes of geometric tuning of the handwriting strokes such as tilt, elongation, and curvature.

Embodiments of the system and method select morphs based on the desired target handwriting. Morphs are a specific type or appearance of a handwritten stroke. The selected morphs are applied purely on geometric features of the strokes, purely on semantic features of the stroke, or some combination of both. Geometric tuning uses the geometric properties of the handwritten strokes without any knowledge of what the handwritten strokes represent. Semantic tuning uses knowledge of the semantic meaning of each stroke in the morphing process. This additional knowledge of the meaning of each character or word in the user's handwriting can by useful when spell correcting and improving the appearance of the user's handwriting.

Embodiments of the handwriting enhancement and correction system and method allow a user explicit control (through controls such as sliders) of how much they want to tune certain features. For example, any combination of geometric tuning and semantic tuning may be used when applying the selected morphs. Moreover, embodiments of the system and method are able to learn the geometric and semantic characteristics of a person's handwriting. These characteristics can be stored as handwriting templates. These handwriting templates can serve as desired target handwriting and be applied to another person's handwriting. This makes it possible to morph and modify person A's handwriting to look more like person B's given person B's handwriting template.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the automatic handwriting morphing and modification system and method implemented in a computing environment.

FIG. 2 is a block diagram illustrating the details of embodiments of the automatic handwriting morphing and modification system and method shown in FIG. 1.

FIG. 3 is a flow diagram illustrating the general operation of embodiments of the automatic handwriting morphing and modification system and method shown in FIG. 1.

FIG. 4 is a flow diagram illustrating the operational details of embodiments of the geometric tuning module shown in FIG. 2.

FIG. 5 is a table illustrating an example of original handwritten text and the morphed and modified handwritten text after processing by embodiments of the system and method.

FIG. 6 is a flow diagram illustrating the operational details of embodiments of the semantic tuning module shown in FIG. 2.

FIG. 7 illustrates a simplified example of a general-purpose computer system on which various embodiments and elements of the automatic handwriting morphing and modification system and method, as described herein and shown in FIGS. 1-6, may be implemented.

### DETAILED DESCRIPTION

In the following description of embodiments of an automatic handwriting morphing and modification system and method reference is made to the accompanying drawings, which form a part thereof, and in which is shown by way of illustration a specific example whereby embodiments of the automatic handwriting morphing and modification system and method may be practiced. It is to be understood that other embodiments may be utilized and structural changes may be made without departing from the scope of the claimed subject matter.

### I. System Overview

Embodiments of the automatic handwriting morphing and modification system and method modify and morph a user's handwriting to resemble and have more of an appearance of a desired target handwriting. This is achieved with replacement of any part of the user's handwriting. The user's handwriting instead is morphed into the desired target handwriting. In addition, the amount of morphing can be controlled, such that that a clear visual correlation is maintained between the user's handwriting and the morphed and modified handwriting output. This ensures that the output looks like the user has written it.

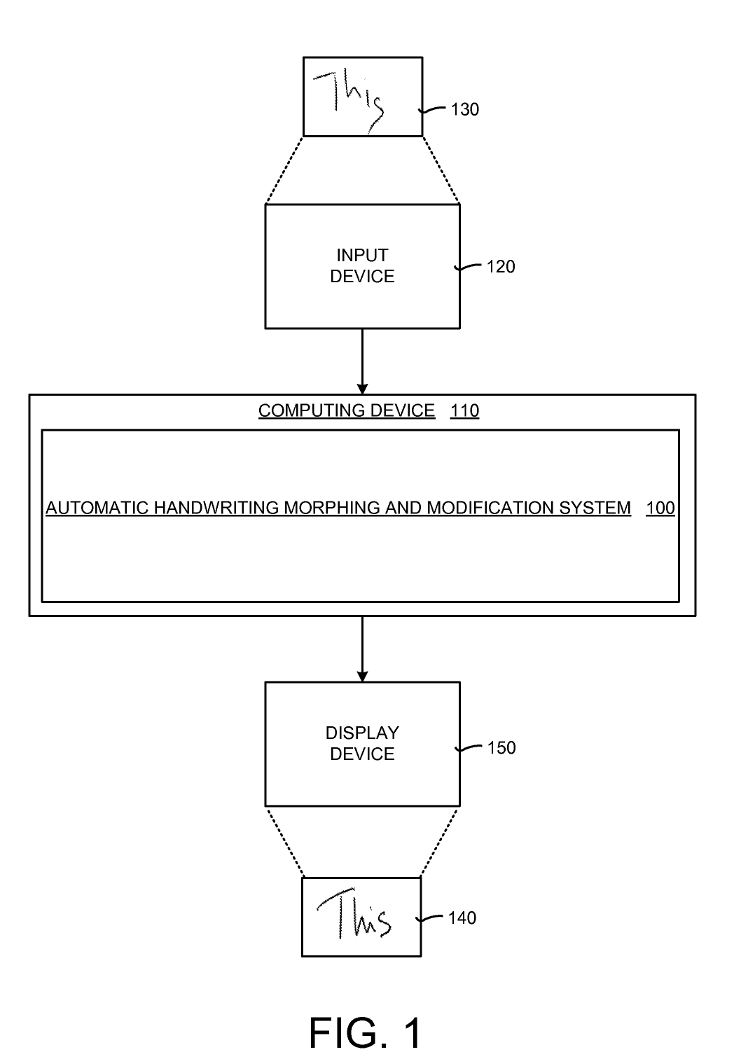

FIG. 1 is a block diagram illustrating a general overview of embodiments of the automatic handwriting morphing and modification system 100 and method implemented in a computing environment. In particular, embodiments of the automatic handwriting morphing and modification system 100 and method are shown implemented on a computing device 110. The computing device 110 may be virtually any device that contains a processor, such as a desktop computer, notebook computer, and mobile phone.

Embodiments of the automatic handwriting morphing and modification system 100 and method use an input device 120 to capture or digitize original handwriting 130 by a user (not shown). This digital version of the user's handwriting 130 is input to embodiments of the system 100 and method.

The user's handwriting 130 then is processed by embodiments of the system 100 and method. The output is a morphed and modified version of the user's handwriting 130, or morphed and modified handwriting 140. As explained in detail below, the morphed and modified handwriting 140 is obtained by altering (but not replacing) handwriting strokes of the user's handwriting 130. The morphed and modified handwriting 140 is presented to the user on a display device 150. The display device may be an integral part of the computing device 110 or may be a separate device, as shown in FIG. 1.

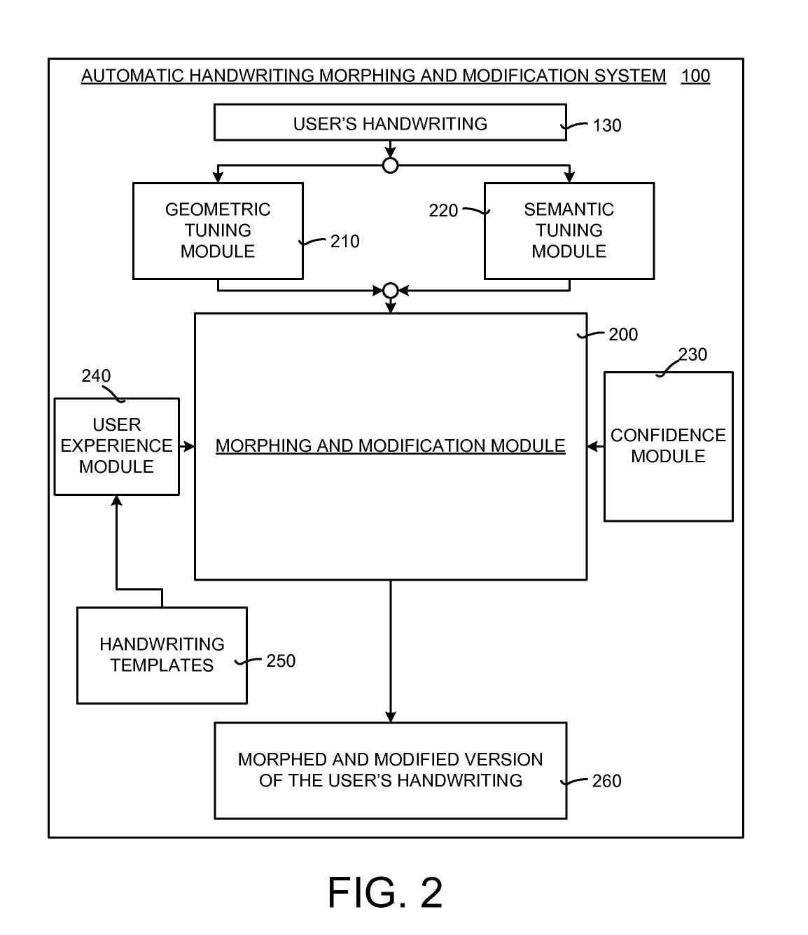

FIG. 2 is a block diagram illustrating the details of embodiments of the automatic handwriting morphing and modification system 100 and method shown in FIG. 1. As shown in FIG. 2, the user's handwriting 130 is input to embodiments of the automatic handwriting morphing and modification system 100 and method. Embodiments of the system 100 and method include a morphing and modification module 200. The module 200 is used to process the user's handwriting based on geometric tuning, semantic tuning, or both.

Embodiments of the system 100 and method include a geometric tuning module 210 that applies selected morphs to the user's handwriting 130 based on the geometric features of the user's handwriting 130. Embodiments of the system 100 and method also include a semantic tuning module 220 that applies selected morphs to the user's handwriting 130 based on the semantic features of the user's handwriting 130.

Embodiments of the automatic handwriting morphing and modification system 100 and method also include a confidence module 230, a user experience module 240, and handwriting templates 250. The confidence module 230 computes a probability that a particular modification to be made to the user's handwriting 130 is correct and displays this to the user. The user can set a confidence threshold that dictates at what confidence level a modification can be made automatically without checking first with the user.

The user experience module 240 provides a user with the tools to dictate how the selected morphs can be applied. In particular, the user can select that the selected morphs are applied using exclusively geometric tuning, using exclusively semantic, or any combination of geometric and semantic tuning. Moreover, the user experience module provides a user with a way to create an original template or desired target handwriting. As explained below, this desired target handwriting provides a target for embodiments of the system 100 and method to aim for when modifying and morphing the user's handwriting 130. In some embodiments, the desired target handwriting has already been made and stored in the form of handwriting templates 250. The resultant output is a morphed and modified version (or morphed and modified handwriting 260) of the user's handwriting 130.

### II. Operational Overview

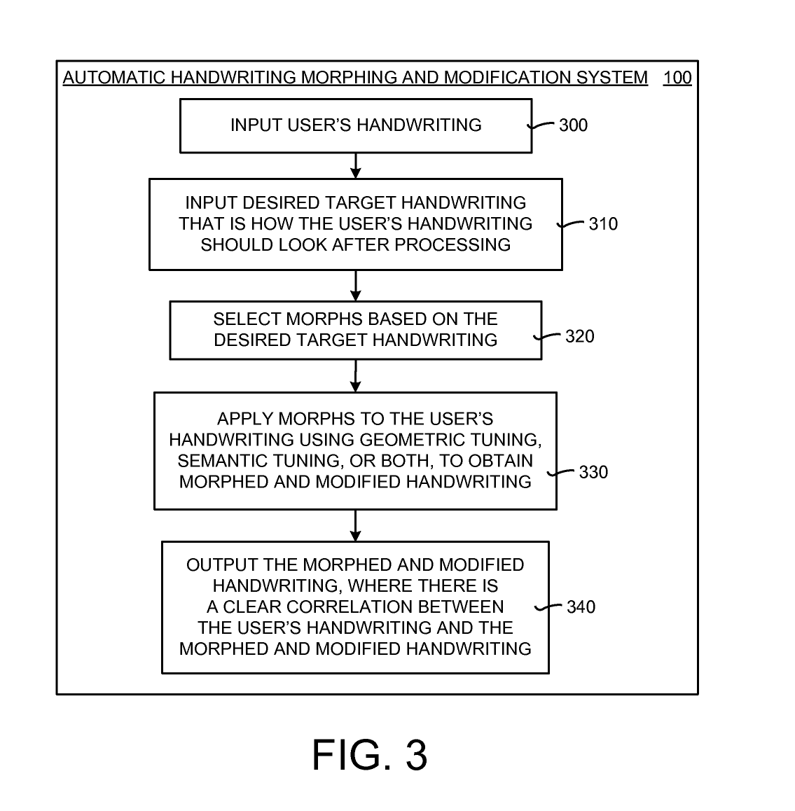

FIG. 3 is a flow diagram illustrating the general operation of embodiments of the automatic handwriting morphing and modification system 100 and method shown in FIG. 1. As shown in FIG. 3, the operation of embodiments of the automatic handwriting morphing and modification system 100 and method begins by inputting the user's handwriting (box 300). This is done to obtain the user's handwriting 130 in a digital format or in digital form. Typically, this is achieved by digitizing a document containing handwriting by the user. In other embodiments, this may be handwriting that the user has entered by writing directly on a digitizing device. The user's handwriting 130 contains handwritten strokes.

The method then inputs a desired target handwriting that dictates the appearance of the user's handwriting 130 after processing (box 310). In other words, the desired target handwriting dictates the desired appearance of the user's handwriting after being changed or altered by the method.

In some embodiments the method includes learning the style and the characteristics of the desired target handwriting. This can include learning the geometric characteristics and semantic characteristics of the target handwriting. In this case the desired target handwriting is different from the user's handwriting 130. The target handwriting can be created by artificially generating the geometric characteristics and the semantic characteristics of the target handwriting. The geometric characteristics and the semantic characteristics of the target handwriting are not based on a particular person's handwriting.

In other embodiments the geometric and semantic characteristics of the target handwriting are generated from previously analyzed handwriting from one or more people. In this situation it is possible to merge the handwriting styles of two or more persons into a single style. Moreover, the method allows a user to vary a first percentage of the geometric and semantic characteristics of a first person's handwriting and vary a second percentage of the geometric and semantic characteristics of a second person's handwriting. In some embodiments the first person and the second person contribute equally to the target handwriting. In other embodiments the target handwriting can have more of the first person's handwriting characteristics (say 80%) and less of the second person's handwriting characteristics (say 20%), or vice versa.

Embodiments of the method then select morphs based on the desired target handwriting (box 320). Morphs are a specific type or appearance of a handwritten stroke. More specifically, morphs are a geometric modification of an existing stroke. Morph results in a new stroke that, while different, bares close similarity with the original stroke. In some embodiments the morphs are selected based on the stored geometric and semantic characteristics of the desired target handwriting. The selected morphs then are applied to the user's handwriting 130 using geometric tuning, semantic tuning, or both (box 330). This yields the morphed and modified handwriting 260.

Applying the selected morphs basically is a way to digitally alter the handwritten strokes of the user's handwriting 130 without any replacement of the handwritten strokes. In other words, the user's handwriting 130 is alter, changed, or morphed to more closely resemble the style and characteristics of the desired target handwriting, but is not replaced by the desired target handwriting. Moreover, a visual correlation is maintained between the user's handwriting 130 and the morphed and modified handwriting 260 such that to an observer it looks like or appears that the same user that wrote the user's handwriting 130 has also written the morphed and modified handwriting 260. Embodiments of the method then output the morphed and modified handwriting 260 (box 340).

### III. Operational Details

The operational details of embodiments of the automatic handwriting morphing and modification system 100 and method will now be discussed. This includes the operation of embodiments of the geometric tuning module 210, the semantic tuning module 220, the confidence module 230, the user experience module 240, and the handwriting templates 250.

Embodiments of the automatic handwriting morphing and modification system 100 and method preserve the characteristics of a user's original handwriting while morphing and modifying the handwritten strokes for a desired effect. This can be thought of as “ink auto-tuning.” In the same way that an audio signal can be morphed and modified to a desired pitch, embodiments of the automatic handwriting morphing and modification system 100 and method morph and modify a user's handwriting 130 to a particular style or effect.

By way of example, embodiments of the system and method can make the user's handwriting 130 more consistent, more rounded, more elongated, more aligned, and so forth, depending on the desired effect. Moreover, embodiments of the automatic handwriting morphing and modification system 100 and method improve the readability and consistency of a user's handwriting 130 while maintaining the personalized and stylized nature of the user's handwritten strokes.

The difference between character substitution with fonts and ink stroke auto-tune of embodiments of the automatic handwriting morphing and modification system 100 and method is that with text substitution each digital character has a single unique visual representation on screen. Rather than performing complete character or word substitution, embodiments of the automatic handwriting morphing and modification system 100 and method instead morph and modify the user's handwriting 130 to achieve the desired style or effect.

Embodiments of the automatic handwriting morphing and modification system 100 and method achieve this morphing and modifying using two types of tuning. A first type of tuning is performed by examining the geometric features of the handwritten text, and is known as “geometric tuning.” A second type of tuning is known as “semantic tuning,” and is achieved by examining semantic features of the handwritten text. Either one or both of these types of tunings may be used when morphing and modifying the user's handwritten text.

### III.A. Geometric Tuning Module

Embodiments of the automatic handwriting morphing and modification system 100 and method include a geometric tuning module 210. Embodiments of the module 210 find the geometric features of strokes (such as the word spacing, word alignment, line alignment, vertical alignment of strokes within the word, roundness correction, as so forth) and apply morphs to those geometric features. This is done without performing character or word recognition. Instead, the geometries of the handwritten strokes are used to determine, for example, the inflection points locations, elongated lines locations, the jitters, the baseline alignment overall, the center, and the horizontal offset.

This allows embodiments of the module 210 to align the lines of handwritten strokes (both horizontally and vertically), morph the handwritten strokes to round out the user's handwriting 130, morph the handwritten strokes to a particular angle (which involves finding dominant straight lines and morphing strokes to align them to a particular angle), morph handwritten strokes horizontally to provide uniform word spacing, and morph handwritten strokes to elongate the writing. This can be performed without the need to know the meaning of what the user wrote.

The idea is that by purely looking at these geometric features, embodiments of the module 210 can apply these geometric features so as to improve the appearance of the user's handwriting 130 where needed. In addition, when there is a gap between the handwritten text, embodiments of the module 210 can ensure that the gaps between the words are roughly aligned so that sentences are nicely spaced.

Embodiments of the module 210 can correct spacing, orientation, line thickness, and curvature, without understanding the semantic meaning of every character and word. In other words, embodiments of the module can modify the handwriting without knowing the meaning of each character in the handwritten text. In order for geometric tuning to work, it is desirable to recognize salient features of the strokes (such as points of max curvatures, end points of strokes, intersection points, and so forth). Such features might point to the handwriting style signature which could be altered by applying different parameters to those features.

A variety of techniques can be used by embodiments of the geometric tuning module 210. These techniques include line straightening techniques and curvature correction or matching techniques. The speed at which the strokes are going up or down can be translated in visibly different line thickness for different handwriting styles. Moreover, embodiments of the module 210 can take into account the pen speed, pressure, and stroke curvature, add the curve fitting at rendering time. This serves to smooth the continuous portions of the stroke while keeping every discontinuity sharp (ends of strokes or sharp turns). This is a technique that can be applied to the handwritten strokes without understanding the semantic meaning of them.

Another technique that can be used by embodiments of the module 210 is a discontinuity alignment technique. If the discontinuities (such as the bottom parts of the letter “m”) are within some threshold (say 5%) from baseline, then the bottom parts will be moved or morphed to the baseline to make the characters aligned.

These are not merely binary operations. In other words, the geometric tuning allows the user to apply a lot or a little of the tuning, as desired. A user is able to determine whether their handwriting is more or less aligned and more or less elongated. This can be achieved along a continuum, such that each of these aspects of the handwriting are more or less configurable.

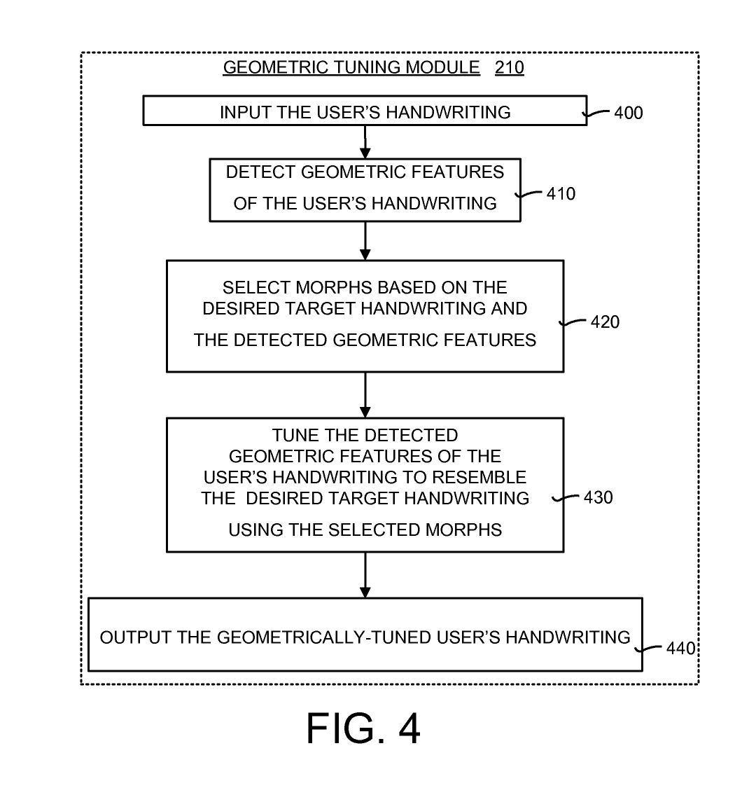

FIG. 4 is a flow diagram illustrating the operational details of embodiments of the geometric tuning module 210 shown in FIG. 2. The operation begins by inputting the user's handwriting 130 (box 400). The geometric features of the user's handwriting 130 then are detected using any one of a number of available techniques (box 410). Embodiments of the module 210 then select morphs based on the desired target handwriting and the detected geometric features (box 420).

Next, geometric tuning is performed by applying the selected morphs to the handwritten strokes of the user's handwriting 130. This tuning causes the detected geometric features of the handwritten strokes to resemble the desired target handwriting by using the selected morphs (box 430). The geometrically-tuned user's handwriting then is output (box 440).

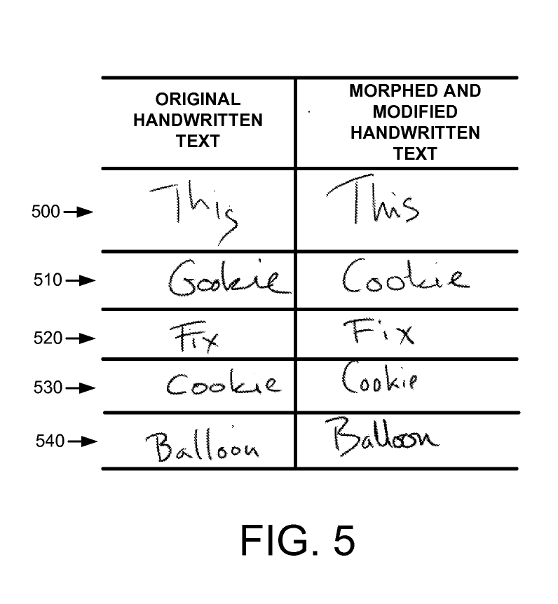

FIG. 5 is a table illustrating an example of original handwritten text and the morphed and modified handwritten text after processing by embodiments of the system 100 and method. As shown in FIG. 5, the first row 500 contains the word “This.” In the left column is the word as written by the user, and in the right column is the work after processing by embodiments of the geometric tuning module 210. In this example, embodiments of the module 210 aligned the characters in the same space in order to improve the appearance of the user's handwriting. No semantic information was used.

### III.B. Semantic Tuning Module

Embodiments of the automatic handwriting morphing and modification system 100 and method also include a semantic tuning module 220. While embodiments of the geometric tuning module 210 look purely at geometric properties, embodiments of the semantic tuning module 220 seek to understand what the user was writing. Embodiments of the module 220 use semantic tuning to apply the selected morphs to the handwritten strokes of the user's handwriting 130.

By way of example, embodiments of the semantic tuning module 220 are able to morph and move handwritten strokes horizontally to provide uniform character spacing. This does not need to be completely uniform, but could be varied to add personal character. Moreover, embodiments of the module 220 are able to morph handwritten strokes vertically to align characters on the same horizontal line. This can be achieved by moving the characters vertically to make them align, growing or shrinking some parts of the stroke to ensure that descenders and ascenders are aligned (such as the letters “p, j, g, k, b, d, l, and so forth), and by growing strokes within characters to match the baseline. For a discontinuity alignment, this could involve morphing the discontinuities (such as the bottom parts of the letter “m”) to the baseline to make the characters align if the discontinuities are within some threshold (such as 5%) from the baseline.

Embodiments of the module 220 also can morph handwritten strokes in a way to extend the strokes and make them more or less cursive. In other words, more or less curved or “fancy.” The characters can also be enlarged or shrunk in order to make them more or less frilly, loopy, or straight. In addition, embodiments of the module 220 can fix crossing characters by spacing them out. For example, if crossing the “t” ends up crossing into the “o” adjacent the “t”, then this can be corrected.

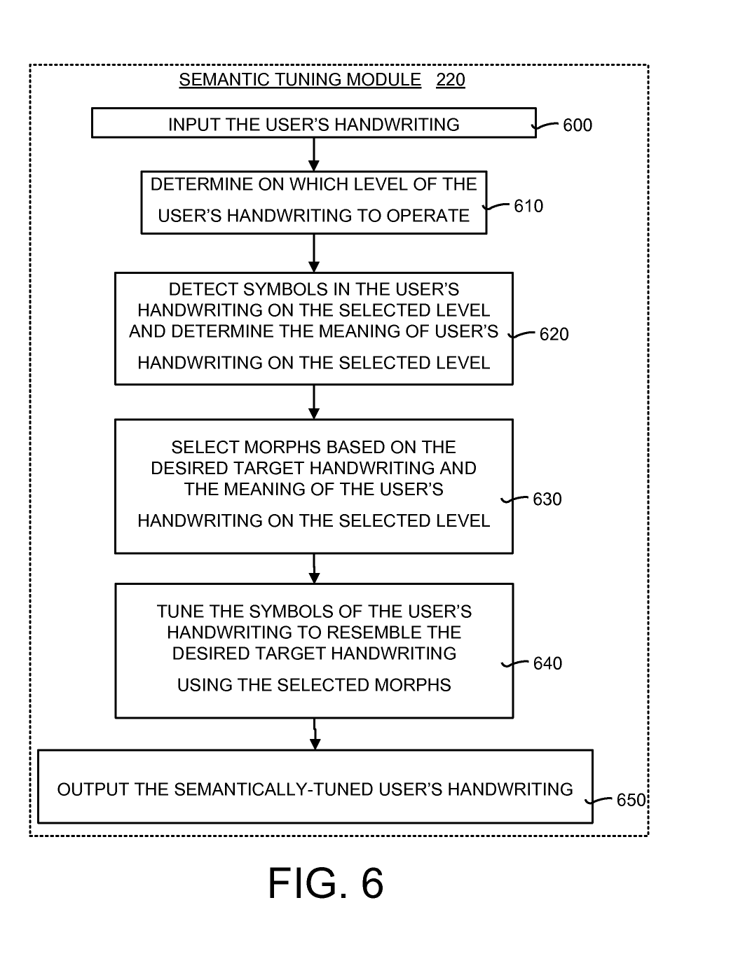

FIG. 6 is a flow diagram illustrating the operational details of embodiments of the semantic tuning module 220 shown in FIG. 2. The operation begins by inputting the user's handwriting 130 (box 600). Next, embodiments of the module 220 determine on which level of the user's handwriting 130 to operate (box 610). These levels include the character level (operates on the character of a word), the sentence level (operates on a sentence), or a line level (operates on an entire line). For example, embodiments of the semantic tuning module 220 can uses align text vertically to improve its appearance.

Embodiments of the semantic tuning module 220 then detect symbols of the user's handwriting on the selected level and determine the meaning of the symbols (box 620). In some situations this may be text or numbers. In some embodiments this is achieved using character and word recognition techniques. For example, embodiments of the module 220 can apply morphing on the character level to uniformly space out the characters, vertically align the characters, or to shrink or grow the characters.

Embodiments of the module 220 can also make printed characters in the user's handwriting 130 appear more cursive by adding connecting lines and so forth. You can use this character map to make the word spacing, orientation, inter-character distance, thickness of the line, curvature (make it smoother) of each of the letters within the word.

Morphs are selected based on the desired target handwriting and the meaning of the symbols in the user's handwriting 130 at the selected level (box 630). The symbols of the user's handwriting 130 then are tuned to resemble the desired target handwriting using the selected morphs (box 640). The semantically-tuned handwriting then is output (box 650).

### III.C. Combination of Geometric Tuning and Semantic Tuning

Embodiments of the automatic handwriting morphing and modification system 100 and method can also use both the geometric tuning module 210 and the semantic tuning module 220. For example, if the characters in the user's handwriting 130 are known, then the ends of the strokes can be expanded to achieve more connected and cursive writing. Conversely, you can characters can be divided or sliced up and shortened so that it looks more like printing. All of this is possible without changing the overall handwriting, but just by changing parts of the strokes.

Referring again to FIG. 5, a second row 510 contains two versions of the word “Cookie.” The original handwritten text has the “C” close to its adjacent “o.” By using both geometric and semantic tuning, the handwriting can be improved. In the third row 520 of FIG. 5 two versions of the word “Fix” are shown. In the original handwritten text the “F” in “Fix” crosses over the adjacent “i.” Purely geometrics without semantic knowledge will not help this problem. What is needed is more of a semantic understanding of the spacing of characters so that they do not cross over each other.

If only the geometric tuning was used then it would tough to tell whether the dot on the “i” is part of some letter or not. It is not desirable to move the “i” away from “F” because it is unknown whether that is part of the character. But if it is semantically known that the “i” does not belong within the “F”, (in other words, if it is known that they are an “F” and an “i”) then the letters can be correct it and spaced out so it is evident which part goes to “i” and which part goes to “F.” The result is a nicely spaced word. This example requires a knowledge of not just at the mechanics of the handwritten strokes (the geometric features) but also understanding what those strokes mean (the semantic features).

### III.D. Confidence Module

Embodiments of the automatic handwriting morphing and modification system 100 and method also contain the confidence module 230. In general, embodiments of the confidence module 230 provide a probabilistic approach to morphing and modifying characters in the user's handwriting 130. The idea is that character in which there is not a high level of confidence (based on some probabilistic approach) are not morphed or modified.

Embodiments of the module 230 morph and modify a user's existing handwritten strokes dependent on the level of confidence that is given the geometric tuning module 210 and the semantic tuning module 220 in interpreting these features. Whether the features are semantic or geometric they still need to be interpreted. For example, embodiments of the module 230 may be very certain that a particular character in the user's handwriting 130 is the letter “T”. Or, it might be uncertain that it is a letter at all. For example, the character or stroke may be part of a drawing. This lowers the “recognition” requirements of the system 100. Based on the level of confidence and a confidence threshold, the character is can be completely morphed, not morphed at all, or anywhere in between on a continuum.

In many cases it is desirable to morph and modify but this process can be used judiciously. If embodiments of the module 230 are uncertain about certain characters or words, or if there is a high level of confusion and the confidence level is below the confidence threshold, then those characters are not morphed or modified. In some embodiments, the system 100 and method can ask a user for additional input. In other embodiments the system 100 and method simply move on as it may become clear at a later time whether to morph and modify those characters.

Embodiments of the system 100 and method are used to change the style and appearance of the user's handwriting (such as the curvature or spacing). This means that the level of correctness or accuracy is not as critical for good results as it is for systems that perform wholesale substitution of a word or character. Moreover, the user has the option to revert back the previous step and undue the morphing and modifying.

Another way to look at it is that embodiments of the system 100 and method can make a change on a portion of the user's handwriting of which there is a high confidence. The other portion of the user's handwriting in which there is less confidence can be left alone. For example, embodiments of the confidence module 230 may find that there is a low confidence in the semantic tuning module's finding that a letter “e” in the user's handwriting 130 is really the letter “o.” Even if the character is not morphed due to the low confidence level, the context of the user's handwriting 130 will probably still be understood. At worst processing by embodiments of the system 100 and method will yield an intermediate result, which will most likely be an improvement over the input user's handwriting 130.

### III.E. User Experience Module and Handwriting Templates

Embodiments of the automatic handwriting morphing and modification system 100 and method also contain the user experience module 240 and the handwriting templates 250. The user experience module 240 provides a user with the tools to dictate how the selected morphs can be applied. These tools include the handwriting templates 250 that allow the user to select the desired target handwriting based on one of more of the handwriting templates 250.

Some embodiments of the module 240 include an interface where the user can load a particular handwriting template, such as an elongated-style font or a flowing-style cursive font. In some embodiments this is achieved using a slider. In other embodiments, a font can be in the style and appearance of a person, such as a John Hancock font or Abraham Lincoln font.

From writing samples, embodiments of the module 240 can learn the canonical characteristics of a particular person's handwriting. Both the geometric and semantic characteristics of the person's handwriting are saved as a handwriting template. One use for a handwriting template like this is to have this template be the desired target handwriting. Embodiments of the system 100 and method then are able to apply this handwriting template to another's handwriting, making it possible to morph and modify a first person's handwriting to look more like a second person's handwriting (given the handwriting template of the second person).

By way of example, suppose from Bob's handwriting embodiments of the system 100 and method extract features that geometrically and semantically are unique to Bob's handwriting. Those unique features of Bob's handwriting are used to create Bob's handwriting template. Bob's handwriting template can be used as a desired target handwriting to morph and modify Mary's handwriting to be more like Bob's handwriting. Perhaps Bob rounds his “o's” while Mary makes them as oval. Thus, maybe one of the visible changes in Mary's handwriting as embodiments of the system 100 and method apply Bob's handwriting template to Mary's handwriting is that, while Mary's text remains mostly intact, her “o's” are a bit more rounded. This is merely one example of a single feature of how Mary's handwriting may change as it is morphed and modified to look more like Bob's handwriting. In addition, embodiments of the module 240 can share and combine handwriting templates 250 in an interesting way to generate a new type of handwriting. For example, what would Martha Stewart's handwriting and John Hancock's writing style look like it they were combined?

Embodiments of the user experience module 240 can combine morphs by having a user interface where the user can dictate how the morphs are applied (such as by setting a variety of different sliders). These settings then are stored as some of the handwriting templates 250. By way of example the user may desire a template of her handwriting. Embodiments of the module 240 can learn the handwriting of that user and store it as a handwriting template. This template would contain the curvature, elongation, and so forth of the handwriting of that user.

Embodiments of the module 240 give the user the ability to select the level of correction desired (auto-tune sliders or auto-tune control panel). This allows the user to apply correction to some subset of features, such as alignment, spacing, sizing, and angle. This makes the auto-correction appear seamless.

### III.F. Enhancement and Reduction of Handwriting

Embodiments of the automatic handwriting morphing and modification system 100 and method are able to not only enhance the user's handwriting 130 but also to reduce it. This means that the user's handwriting 130 can be enhanced by taking the user's printed style of handwriting where the letters are separate and connecting them to make the user's handwriting more cursive. On the other hand, the user's handwriting can be reduced by taking the user's cursive style of handwriting where the letters of the word are connected and separating the letters to make them appear like printing. All this is achieved while retaining the style and appearance of the user's handwriting 130.

By way of example, suppose that Mary writes in a cursive style where the letters of each word are connected. Embodiments of the system 100 and method can take the cursive style of Mary's handwriting and make it appear like printed script. This is achieved by taking away from the individual handwritten strokes, by making each character separate and not connected. The end result appears as if Mary printed each character in her own handwriting.

Referring again to FIG. 5, in a fourth row 530 is shown an example of reduction. In the original handwritten text the word “Cookie” is writing in cursive with the letters “k” and “i” connected. In the morphed and modified handwritten text a reduction has occurred such that each of the letters of the word are separate. However, note that the original style of the handwriting of the user is maintained.

In a fifth row 540 of FIG. 5 is shown an example of enhancement. In the original handwritten text the word “Balloon” is written in printed script with each of the letters separate from each other. After processing by embodiments of the system 100 and method, the morphed and modified handwritten text shows that an enhancement has occurred such that many of the letters in the word “Balloon” now are connected. This gives the appearance of going from a printed script style of handwriting to a cursive style of handwriting. Again, the original style of the handwriting of the user is maintained.

Both enhancement and reduction of handwriting strokes by embodiments of the system 100 and method are performed by morphing and modifying the user's handwriting 130. At no time is there any complete substitution as most of the existing stroke in the user's handwriting 130 is retained. Instead, embodiments of the system 100 and method are changing the user's handwriting 130 to conform more to a desired target handwriting.

### IV. Exemplary Operating Environment

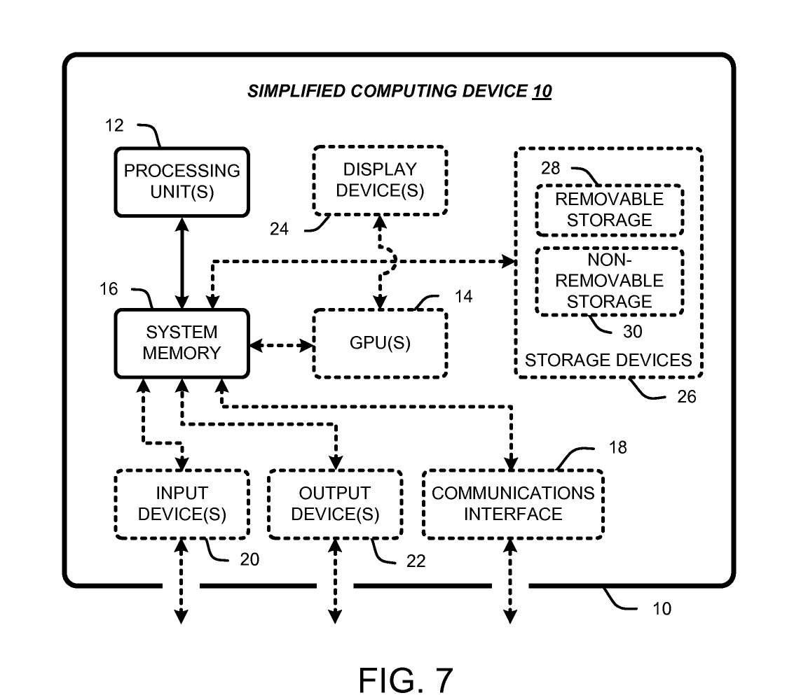

Embodiments of the automatic handwriting morphing and modification system 100 and method described herein are operational within numerous types of general purpose or special purpose computing system environments or configurations. FIG. 7 illustrates a simplified example of a general-purpose computer system on which various embodiments and elements of the automatic handwriting morphing and modification system 100 and method, as described herein and shown in FIGS. 1-6, may be implemented. It should be noted that any boxes that are represented by broken or dashed lines in FIG. 7 represent alternate embodiments of the simplified computing device, and that any or all of these alternate embodiments, as described below, may be used in combination with other alternate embodiments that are described throughout this document.

For example, FIG. 7 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement embodiments of the automatic handwriting morphing and modification system 100 and method described herein, the device should have a sufficient computational capability and system memory to enable basic computational operations. In particular, as illustrated by FIG. 7, the computational capability is generally illustrated by one or more processing unit(s) 12, and may also include one or more GPUs 14, either or both in communication with system memory 16. Note that that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 7 may also include other components, such as, for example, a communications interface 18. The simplified computing device of FIG. 7 may also include one or more conventional computer input devices 20 (e.g., pointing devices, keyboards, audio input devices, video input devices, haptic input devices, devices for receiving wired or wireless data transmissions, etc.). The simplified computing device of FIG. 7 may also include other optional components, such as, for example, one or more conventional computer output devices 22 (e.g., display device(s) 24, audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 7 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the automatic handwriting morphing and modification system 100 and method described herein, or portions thereof, may be stored, received, transmitted, or read from any desired combination of computer or machine readable media or storage devices and communication media in the form of computer executable instructions or other data structures.

Finally, embodiments of the automatic handwriting morphing and modification system 100 and method described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Moreover, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for digitally altering a user's handwriting, comprising:
input the user's handwriting containing handwritten strokes; and
digitally altering the handwritten strokes without any replacement of the handwritten strokes to obtain morphed and modified handwriting based on a set of morph rules.

2. The method of claim 1, further comprising specifying the set of morph rules by having the user tune a level of morphing through a user interface.

3. The method of claim 1, wherein digitally altering the handwritten strokes further comprises maintaining a visual correlation between the user's handwriting and the morphed and modified handwriting such that it looks like a same user that has written the handwriting has also written the morphed and modified handwriting.

4. The method of claim 1, wherein digitally altering the handwritten strokes further comprises:
selecting morphs based on the desired target handwriting, where a morph is a modification of the handwritten stroke; and
applying the selected morphs to the handwritten strokes to obtain the morphed and modified handwriting.

5. The method of claim 4, further comprising using geometric tuning to apply the selected morphs to the handwritten strokes.

6. The method of claim 5, further comprising:
detecting geometric features of the handwritten strokes; and
selecting the selected morphs based on the detected geometric features.

7. The method of claim 6, further comprising tuning the detected geometric features of the handwritten strokes to resemble the desired target handwriting using the selected morphs.

8. The method of claim 4, further comprising using semantic tuning to apply the selected morphs to the handwritten strokes.

9. The method of claim 8, further comprising:
determining a level of the user's handwriting on which to operate;
detecting symbols in the user's handwriting on the selected level; and
determining a meaning of the symbols in the user's handwriting on the selected level.

10. The method of claim 9, further comprising:
selecting the selected morphs based on the desired target handwriting and the meaning of the symbols in the user's handwriting on the selected level; and
tuning the symbols in the user's handwriting to resemble the desired target handwriting using the selected morphs.

11. A method for modifying and morphing a user's handwriting, comprising:
obtaining the user's handwriting in digital form;
learning a style and characteristics of a target handwriting that is different from the user's handwriting;
selecting morphs based on the target handwriting to obtain selected morphs, where a morph is a modification of a handwritten stroke; and
applying the selected morphs to the user's handwriting without any replacement of the user's handwriting to modify and morph the user's handwriting to resemble the style and characteristics of the target handwriting.

12. The method of claim 11, further comprising:
learning geometric characteristics and semantic characteristics of the target handwriting;
storing the geometric characteristics and semantic characteristics; and
selecting the selected morphs based on the stored geometric characteristics and semantic characteristics.

13. The method of claim 12, further comprising artificially generating the geometric characteristics and semantic characteristics of the target handwriting such that the geometric characteristics and semantic characteristics are not based on a particular person's handwriting.

14. The method of claim 12, further comprising automatically creating the geometric characteristics and semantic characteristics of the target handwriting from previously analyzed handwriting from at least one person.

15. The method of claim 14, further comprising combining the geometric characteristics and semantic characteristics of a first person's handwriting and the geometric characteristics and semantic characteristics of a second person's handwriting to obtain the geometric characteristics and semantic characteristics of the target handwriting such that the target handwriting is a combination of the first person's handwriting and the second person's handwriting.

16. The method of claim 15, further comprising allowing the user to vary a first percentage of the geometric characteristics and semantic characteristics of the first person's handwriting in the target handwriting and a second percentage of the geometric characteristics and semantic characteristics of the second person's handwriting in the target handwriting such that the first percentage and the second percentage are not equal.

17. A method for changing an appearance of a user's handwriting, comprising:
digitizing the user's handwriting containing handwritten strokes;
obtaining a desired target handwriting that dictates how the appearance of the user's handwriting should be changed;
selecting morphs based on the desired target handwriting to obtain selected morphs, where a morph is a modification of the handwritten stroke; and
applying the selected morphs to the user's handwriting without any replacement of the user's handwriting using geometric tuning and semantic tuning to obtain morphed and modified handwriting that reflects a change in the appearance of the user's handwriting while maintaining a correlation between the user's handwriting and the morphed and modified handwriting.

18. The method of claim 17, further comprising:
selecting a first percentage representing how much geometric tuning is used in applying the selected morphs, wherein the first percentage varies from zero to one-hundred percent; and
selecting a second percentage representing how much semantic tuning is used in applying the selected morphs, wherein the second percentage varies from zero to one-hundred percent.

19. The method of claim 18, further comprising manually creating the desired target handwriting by selecting attributes of geometric tuning such as tilt, elongation, and curvature of the desired target handwriting.

20. The method of claim 18, further comprising reducing the user's handwriting that is in a cursive style to the desired target handwriting that is in a printed style to obtain the morphed and modified handwriting.
